(19) United States
(12) Patent Application Publication
(10) Pub. No.: US 2007/0101397 A1
(43) Pub. Date: May 3, 2007

(54) Interoperability of network components having different identification schemes

(76) Inventors: Bakri Aboukarr, Kanata (CA); Arkin Aydin, Nepean (CA); Bart Wim Cornelius Geldof, Wetteren (BE); Geert Heyninck, Kapellen (BE); Robert W. MacIntosh, Carp (CA); Mary Ann Condie, Kanata (CA); Gregory Erich Gyetko, Dunrobin (CA)

Correspondence Address: Arnold B. Silverman;Eckert Seamans Cherin & Mellott, LLC, 44th Floor, 600 Grant Street, Pittsburgh, PA, 15219, US

(21) Appl. No.: 11/264,476

(22) Filed: Nov. 1, 2005

(51) Int. Cl. H04N 7/173; H04N 7/16

(52) U.S. Cl. 725/140; 725/132

(57) ABSTRACT

An apparatus and method for configuring an identifier in accordance with a predetermined identification scheme for a particular component within a network, the particular component being incapable of providing one or more value(s) for parameters of the predetermined identification scheme is provided. The apparatus comprises a module for determining that the particular component requires the identifier in accordance with the predetermined identification scheme and a processor for configuring the identifier in accordance with the predetermined identification scheme using one or more parameter value(s) available for components incapable of providing the parameter value(s) in accordance with the predetermined identification scheme. In some embodiments the identifier is assigned to the component.

### FIELD OF THE INVENTION

The present invention relates to identifiers for components within a network.

### BACKGROUND

Telephone networks typically house network components in cabinets and those components are identified by their rack, shelf, and slot identifiers. The identifiers are manually set when the components are installed, for example by setting DIP switches on a backplane of shelf.

In ATM (Asynchronous Transfer Mode) systems, the racks and shelves are connected by cables in a daisy chain topology. To add or remove a slot, shelf or rack, it is necessary to disconnect and reset the NT (Network Termination) so that the host system can figure out the entire chain again.

In a star topology, network components all connect to the host system and it is not necessary to reset the NT in order to add or remove components.

Multi-shelf systems are typically constructed of identical shelves, with each shelf being differentiated by a unique identifier (ID). This ID is typically manually configured, for example using DIP switches, at installation time. Because DIP switches are manually set they are prone to errors.

Plug and play devices are not designed to be manually configured during installation. Systems that use plug and play devices are configured to detect and recognise the device when the device is connected. If the plug and play device is a sealed unit, manual configuration requires that the unit be opened for configuration at the time of installation risking improper re-sealing. Configuration switches which could be externally adjusted at installation of a sealed unit are prohibitively expensive.

### SUMMARY OF THE INVENTION

In one aspect of the present invention, there is provided an apparatus for configuring an identifier in accordance with a predetermined identification scheme for a particular component within a network, the particular component being incapable of providing one or more value(s) for parameters of the predetermined identification scheme, the apparatus comprising: a module for determining that the particular component requires an identifier in accordance with the predetermined identification scheme; and a processor for configuring the identifier in accordance with the predetermined identification scheme using one or more parameter value(s) available for components incapable of providing the parameter value(s) in accordance with the predetermined identification scheme.

In another aspect of the present invention, there is provided a method for configuring an identifier in accordance with a predetermined identification scheme for a particular component within a network, the particular component being incapable of providing one or more value(s) for parameters of the predetermined identification scheme, the method comprising: determining that the particular component requires an identifier in accordance with the predetermined identification scheme; configuring the identifier in accordance with the predetermined identification scheme using one or more parameter value(s) available for components incapable of providing the parameter value(s) in accordance with the predetermined identification scheme.

In still another aspect of the present invention, there is provided an apparatus for enabling identification of a component in a network in accordance with a predetermined identification scheme for identifying components in the network, comprising: a module for determining, at a network element, a first identifier for said component other than an identifier in accordance with the identification scheme; a processor, responsive to the determination made by said module, for assigning a second identifier to said component, wherein the second identifier is permitted according to said predetermined identification scheme.

Other aspects and features of the present invention will become apparent, to those ordinarily skilled in the art, upon review of the following description of the specific embodiments of the invention.

### BRIEF DESCRIPTION OF THE DRAWINGS

Embodiments of the invention will now be described in greater detail with reference to the accompanying drawings, in which:

FIG. 1 is a block diagram of a system in which embodiments of the present invention can be implemented;

FIG. 2 is a flowchart of a method in accordance with one embodiment of the present invention;

FIG. 3 is a flowchart of a method in accordance with one embodiment of the present invention;

FIG. 4 is a block diagram of an apparatus in accordance with one embodiment of the present invention; and

FIG. 5 is a block diagram of a host system in accordance with one embodiment of the present invention.

### DETAILED DESCRIPTION OF THE PREFERRED EMBODIMENTS

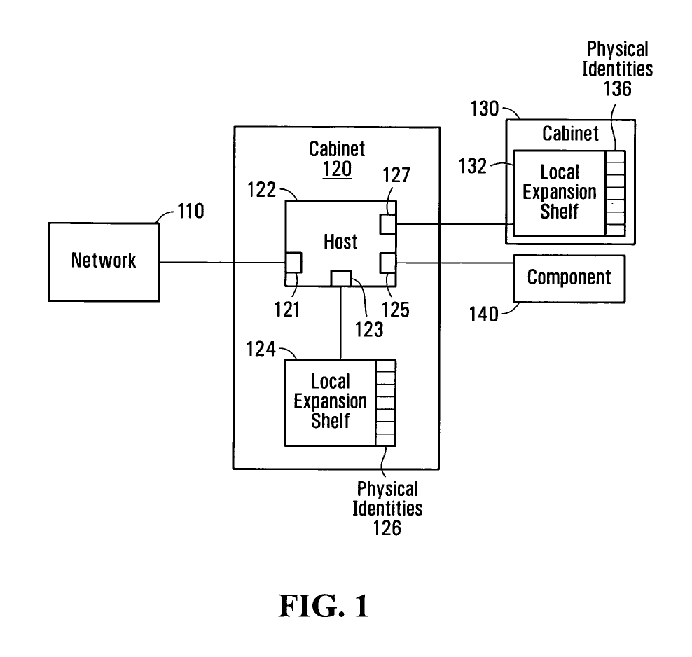

FIG. 1 is a block diagram of an example of a system 100 in which embodiments of the present invention may be implemented. The system comprises a host node 122 which has four ports 121, 123, 125, and 127. Examples of ports are SFPs (Small Form-factor Pluggable). The host node 122 is connected to a network 110 through port 121. The host node 122 receives signals from the network 110 through port 121 for distribution to network components supported by the host node. The host node 122 is physically located in a cabinet 120. The cabinet 120 in this embodiment also houses a local expansion shelf 124, which is in communication with the host node 122 through port 123. The local expansion shelf 124 has physical identifiers 126, which are manually set when the local expansion shelf 124 is installed. The host node 122 is also in communication with a remote expansion shelf 132 through port 127 and a component 140 through port 125. The remote expansion shelf 132 is located in a cabinet 130 and has physical identifiers 136 which are manually set when the remote expansion shelf 132 is installed in the cabinet 130. The physical identifiers 126 and 136 are used as parameter values to identify the expansion shelves 124 and 130, respectively, in accordance with a predetermined identification scheme. The local and remote expansion shelves 124 and 132 expand the number of lines over which the host can direct signals. In some embodiments, each expansion shelf is comprised of a plurality of LTs (Line Terminations) and each LT has its own identifier configured in accordance with the predetermined identification scheme. In some embodiments, the component 140 has one LT with an identifier which is not in accordance with the predetermined identification scheme.

The system of FIG. 1 is only one example of a system in which embodiments of the present invention can be implemented. It is to be understood that other embodiments comprise any number of cabinets, shelves and components in any number of configurations.

In operation, the physical identifiers 126 and 136 are provided to the host node 122 by the local and remote expansion shelves 124 and 130 upon initialisation of the shelves. In some embodiments, the physical identifiers 126 and 136 are provided in a predetermined identification scheme, such as rack ID, shelf ID, slot ID.

The component 140 is incapable of providing parameter values required by the predetermined identification scheme. In some embodiments, the component 140 is a plug and play device. In some other embodiments, the component 140 is a sealed unit with no means of manually setting physical identifiers. In some embodiments, the component 140 is an expansion shelf with multiple LTs or an expansion module with a single LT. In some cases, the component 140 is provided with an identifier, such as an ethernet address or a MAC (Medium Access Control) address during manufacturing. When the component 140 connects to the host node 122, the component 140 sends a message to the host node indicating that the component 140 is connected. In some embodiments, the message contains the type of device of the component 140 and/or an identifier that is not in accordance with the predetermined identification scheme.

In some embodiments of the present invention, when the host node 122 receives the message from the component 140 without an identifier in accordance with the predetermined identification scheme, it will determine on which port the message was received. Each port has a parameter value assigned to it for at least one of the parameters of the predetermined identification scheme. The host node 122 will determine the parameter value for the port on which the message was received, port 125 in this case. The host node 122 uses that parameter value to configure a unique identifier for the component 140 in accordance with the predetermined identification scheme. In some embodiments, the parameter value of a port is a value for a shelf ID. In these cases, there may also be a rack ID and a slot ID reserved for specific types of components, such as a sealed unit, that are incapable of providing rack, shelf and slot IDs. Thus, the host node 122 configures a unique identifier made up of the reserved rack ID for components of the same type as component 140, the shelf ID assigned to port 125, and the slot ID reserved for components of the same type as component 140. For example, if rack ID 3 is reserved for components such as component 140, and slot ID 1 is to be given to any device without a slot ID, and the port 125 is associated with shelf ID 2, the component 140 will be assigned the identifier: rackID=3; shelfID=2; slotID=1.

The configuration in which the expansion shelves 124 and 122 and the component 140 are connected to the host node is known as a star configuration, with only one component connected to each port. In other embodiments, more than one component can be chained together and connected to a single port. In this case if two components of the type of the component 140 are chained together, the host will recognise that there is more than one device and assign two unique identifiers. For example, one device may be assigned slotID 1 and the other may be assigned slotID 2. Because both share the same port they will have the same shelfID. Likewise the rackID will be the same for both components.

In systems, such as that described with reference to FIG. 1, host systems need to support both expansion shelves that have physical identifiers using DIP switches and sealed devices that do not have any DIP switches. To achieve this, the LTs in the expansion shelves and the sealed devices use different parameters in their respective boot sequences that let the host node distinguish between them. However, the host node models both the expansion shelves and the sealed devices with shelf identifiers. The shelf ID of an expansion shelf is based on a standard DIP switch setting on a backplane of the expansion shelf. For the sealed device, its shelf ID will be deduced from a port number on network connection card in the host system to which it is connected.

Embodiments of the present invention address the problem of shelf identification in multi-shelf systems, or more specifically providing shelf identification interoperability between plug and play and non-plug and play equipment at a host node. To solve this problem, some embodiments of the invention model both the non-plug and play equipment, such as an expansion shelf, and the plug and play equipment with a shelf identifier. The shelf identifier of the non-plug and play equipment is based on a standard DIP switch setting. For the plug and play equipment, its shelf identifier will be deduced from an interface identifier, such as a port number of the port to which it is connected on the host node. This technique enables either type of equipment to be connected to any port of the host system, and as such provides important flexibility in network configuration.

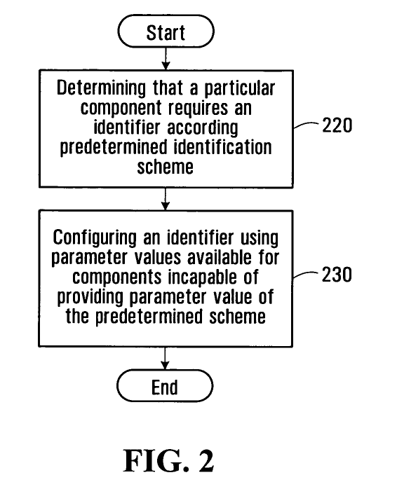

FIG. 2 is a flowchart of a method in accordance with one embodiment of the present invention. The method is for configuring an identifier in accordance with a predetermined identification scheme for a particular component within a network. The particular component in this case is incapable of providing one or more value(s) for parameters of the predetermined identification scheme. In some embodiments, the predetermined identification scheme is based on physical parameters of components in the network, such as the rack, shelf and slot IDs of the components.

Step 220 comprises determining that the particular component requires the identifier in accordance with the predetermined identification scheme. In some embodiments, this involves detecting that the particular component is connected to the network and that it does not have an identifier in accordance with the predetermined identification scheme. The next step, Step 230, comprises configuring the identifier in accordance with the predetermined identification scheme using one or more parameter value(s) available for components incapable of providing the parameter value(s) in accordance with the predetermined identification scheme. In some embodiments, the parameter value is a value reserved for components connected to a particular interface. In still other embodiments, the parameter value is selected from values that have not been assigned to another component. In some embodiments, the configuration involves determining a shelf ID associated with the interface to which the component is connected and using that as the shelf ID for the identifier. In other embodiments, the shelf ID for the interface is added to a rack ID and a slot ID associated with components incapable of providing parameter value(s) in accordance with the predetermined identification scheme. In some embodiments, each type of component incapable of providing parameter values in accordance with the predetermined scheme is associated with a respective parameter value, such as a rack ID.

In some embodiments, the method further comprises assigning the identifier to the particular component. In some cases, assigning the identifier comprises recording the identifier and a name of the particular component on a storage medium. The storage medium may also be used to store a location field for each component in the network where the geographic location of the respective component is recorded.

In some embodiments, determining that the particular component requires an identifier comprises receiving a message from the particular component indicating that the particular component has been connected to the network and determining that the message does not contain an identifier in accordance with the predetermined identification scheme. In some cases, the message also comprises an ethernet address of the particular component and/or the type of device of the particular component.

In some embodiments, the parameter values available for components incapable of providing the parameter value(s) are determined according to which interface a respective component is connected.

In the method of some embodiments, configuring the identifier comprises accessing a storage medium having an interface identifier for the interface stored thereon, retrieving the interface identifier and formulating the identifier based on the interface identifier. In some cases configuring the identifier comprises combining the interface identifier with at least one other parameter having a value assigned to components of a type the same as the particular component.

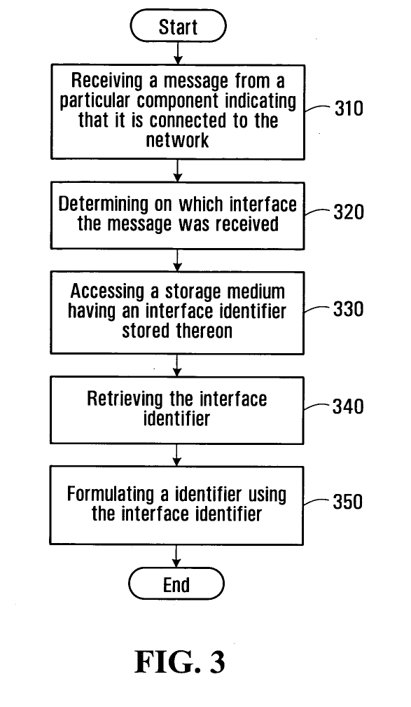

FIG. 3 is a flowchart of a method according to one embodiment of the present invention. The method is for configuring an identifier in accordance with a predetermined identification scheme for a particular component within a network. The particular component, in this case, is incapable of providing one or more value(s) for parameters of the predetermined identification scheme. The first step is receiving a message from the particular component indicating that the component is connected to the network (Step 310). The next step is determining on which interface the message was received (Step 320). In some embodiments the interface is a port, such as an SFP on a host system. Then, a storage medium is accessed (Step 330). The storage. medium has an interface identifier associated with the interface stored thereon. The interface identifier is then retrieved (Step 340). The identifier for the particular component is then formulated using the interface identifier as a parameter value for the predetermined identification scheme (Step 350).

The methods of the embodiments of the present inventions may be implemented in any combination of hardware and/or software. In some embodiments, the method is implemented by computer-executable instructions stored on a computer-readable medium.

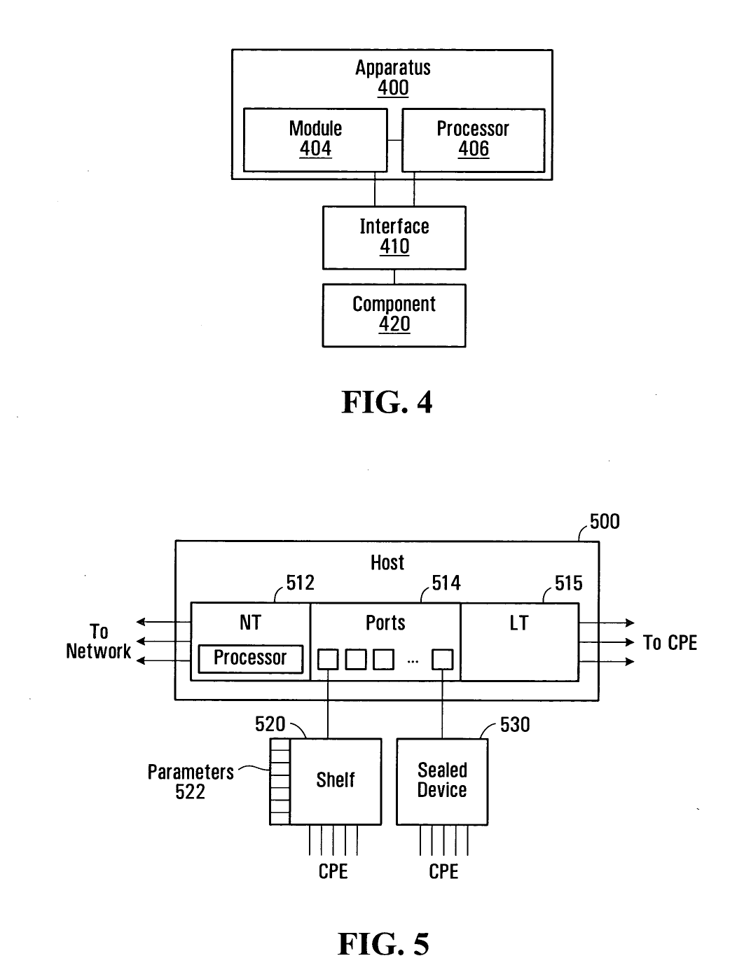

FIG. 4 is a block diagram for an apparatus 400 in accordance with one embodiment of the present invention. The apparatus 400 is for configuring an identifier in accordance with a predetermined identification scheme for a particular component 420 within a network, the particular component 420 being incapable of providing one or more value(s) for parameters of the predetermined identification scheme. The apparatus 400 is comprised of a module 404 and a processor 406. In one embodiment, the module 404 is configured to determine that the particular component 420 requires the identifier in accordance with the predetermined identification scheme. In this embodiment, the module 404 is in communication with the component 420 through an interface 410. The processor 406 of this embodiment is for configuring the identifier in accordance with the predetermined identification scheme using one or more parameter value(s) available for components incapable of providing the parameter value(s) in accordance with the predetermined identification scheme.

In another embodiment, the module 404 is for determining, at a network element, a first identifier for the component other than an identifier in accordance with the identification scheme. The module 404 may determine the first identifier as a result of the network receiving a. message from the component containing the first identifier. In this embodiment, the processor 406 is for, based on said determination, assigning a second identifier to the component, the second identifier being permitted according to the predetermined identification scheme. In some cases, the second identifier for the component comprises an identifier identifying an interface of the network element to which the component is connected. In some embodiments the network element is a host node. The module 404 in some embodiments determines the identity of the interface of the network element to which the component is connected in response to a signal received from the component indicating that the component is connected to the network element.

In some cases the module 404 is part of the processor 406. In some embodiments, the interface 410 forms part of the apparatus 400. In some embodiments the apparatus 400 also comprises a storage medium for recording the identifier in accordance with the predetermined identification scheme and, associated therewith, another identifier for the component. In some embodiments, the apparatus comprises a display for displaying the identifiers of each component in the network.

Some embodiments of the present invention comprise the apparatus 400 connected to the component 420 and to another component capable of providing parameter values for the parameters of the predetermined identification scheme.

FIG. 5 is a block diagram of a host system 500 configured to implement. one embodiment of the present invention. The host system 500 comprises a NT (Network Termination) 512, a plurality of ports 514 and a LT 515. Although the host system of FIG. 5 has one NT and one LT, host systems in accordance with the present invention can comprise any number of LTs and NTs. The NT 512 has a processor and a plurality of lines leading to a network (3 lines are shown in the Figure). The processor in the NT 512 can be used to perform the functionality of the processor 406 described with reference to FIG. 4. The LT has a plurality of lines (3 shown) leading to CPEs (Customer Premise Equipment). The ports 514 are used to connect network components to the host system 500. In this embodiment, one shelf 520 and one sealed device 530 are connected to respective ports. It is to be understood that any number and combination of components can be connected to the host system through the ports 514. The shelf 520 has parameters 522 that are manually set when the shelf is installed. In some embodiments, these parameters comprise rack ID, shelf ID and slot ID. The sealed device 530 has no parameters that can be manually set but does have a unique manufacturer installed identifier. In some embodiments, the sealed device has an ethernet or a MAC address unique to the device. Both the shelf 520 and the sealed device 530 have a plurality of lines leading to CPEs (5 shown per device). To initiate the shelf 520, the shelf sends a message to the host system 500 with an identifier in accordance with a predetermined identification scheme and comprised of the parameters 522. To initiate the sealed device 530, the device sends a message to the host system 500 indicating that it is connected and giving its manufacturer installed identifier and what type of device it is. The host system receives the signal and recognises that the identifier is not in accordance with the predetermined identification scheme. Therefore, the host system 500 determines on which port the signal was received and that port has an identifier associated with it. The host system 500 uses the identifier associated with the port to configure an identifier in accordance with the predetermined identification scheme for the sealed device 530.

The above described embodiments illustrate that both components that can provide an identifier in accordance with a predetermined identification scheme and components that are incapable of doing so can operate in the same network by configuring and assigning an identifier in accordance with the predetermined identification scheme to any component that does not have such an identifier.

What has been described is merely illustrative of the application of the principles of the invention. Other arrangements and methods can be implemented by those skilled in the art without departing from the spirit and scope of the present invention.

1. An apparatus for configuring an identifier in accordance with a predetermined identification scheme for a particular component within a network, the particular component being incapable of providing one or more value(s) for parameters of the predetermined identification scheme, the apparatus comprising:
a module for determining that the particular component requires an identifier in accordance with the predetermined identification scheme; and
a processor for configuring the identifier in accordance with the predetermined identification scheme using one or more parameter value(s) available for components incapable of providing the parameter value(s) in accordance with the predetermined identification scheme.

2. The apparatus of claim 1, further comprising an interface for receiving a message from the particular component indicating that the particular component is connected to the network.

3. The apparatus of claim 1, further comprising a storage medium for recording the identifier in accordance with the predetermined identification scheme and, associated therewith, another identifier for the component.

4. The apparatus of claim 1, wherein the module is part of the processor.

5. The apparatus of claim 2, wherein the parameter value(s) available is/are determined according to the interface on which the message is received.

6. The apparatus of claim 1 connected to the component and to another component capable of providing parameter values for the parameters of the predetermined identification scheme.

7. A method for configuring an identifier in accordance with a predetermined identification scheme for a particular component within a network, the particular component being incapable of providing one or more value(s) for parameters of the predetermined identification scheme, the method comprising:
determining that the particular component requires an identifier in accordance with the predetermined identification scheme;
configuring the identifier in accordance with the predetermined identification scheme using one or more parameter value(s) available for components incapable of providing the parameter value(s) in accordance with the predetermined identification scheme.

8. The method of claim 7, further comprising assigning the identifier to the particular component.

9. The method of claim 8, wherein assigning the identifier comprises recording the identifier and a name of the particular component on a storage medium.

10. The method of claim 7, wherein determining that the particular component requires an identifier comprises:
receiving a message from the particular component indicating that the particular component has been connected to the network;
determining that the message does not contain an identifier in accordance with the predetermined identification scheme.

11. The method of claim 7, wherein the parameter values available for components incapable of providing the value(s) are determined according to which interface a respective component is connected.

12. The method of claim 11, wherein configuring the identifier comprises:
accessing a storage medium having an interface identifier for the interface stored thereon;
retrieving the interface identifier; and
formulating the identifier based on the interface identifier.

13. The method of claim 12, wherein formulating the identifier comprises combining the interface identifier with at least one other parameter having a value assigned to components of a type the same as the particular component.

14. The method of claim 10, wherein the message further comprises at least one of an ethernet address of the particular component and the type of device of the particular component.

15. The method of claim 7, wherein the predetermined identification scheme is based on physical parameters of components in the network.

16. A computer readable medium having computer readable instructions stored thereon that when executed implement the method of claim 7.

17. An apparatus for enabling identification of a component in a network in accordance with a predetermined identification scheme for identifying components in the network, comprising:
a module for determining, at a network element, a first identifier for said component other than an identifier in accordance with the identification scheme;
a processor, responsive to the determination made by said module, for assigning a second identifier to said component, wherein the second identifier is permitted according to said predetermined identification scheme.

18. The apparatus as claimed in claim 17, further comprising a storage medium for storing a record containing the first identifier and, associated therewith, the second identifier.

19. The apparatus as claimed in claim 17, wherein the second identifier for said component comprises an identifier identifying an interface of said network element to which said component is connected.

20. The apparatus as claimed in claim 19, wherein said module determines the identity of the interface of the network element to which said component is connected in response to a signal received from the component indicating that the component is connected to the network element.
